(19) United States
(12) Patent Application Publication
(10) Pub. No.: US 2026/0270769 A1
(43) Pub. Date: Sep. 10, 2026

(54) QUALITY OF SERVICE PROCESSING METHOD AND APPARATUS FOR SERVICE DATA PACKET SET, READABLE MEDIUM AND DEVICE

(71) Applicant: TENCENT TECHNOLOGY (SHENZHEN) COMPANY LIMITED, Shenzhen (CN)

(72) Inventor: Yixue LEI, Shenzhen (CN)

(73) Assignee: TENCENT TECHNOLOGY (SHENZHEN) COMPANY LIMITED, Shenzhen (CN)

(21) Appl. No.: 19/660,564

(22) Filed: Apr. 28, 2026

Related U.S. Application Data
(63) Continuation of application No. PCT/CN2024/131394, filed on Nov. 11, 2024.

(30) Foreign Application Priority Data
Dec. 18, 2023 (CN) 202311745643.4

(51) Int. Cl. H04W 28/02

(52) U.S. Cl. CPC H04W 28/0268

(57) ABSTRACT

A method, an apparatus, and computer-readable storage medium for a service data packet set is provided. The method obtains quality of service (QoS) requirement information for a service data flow, the QoS requirement information indicating that a service data packet set in the service data flow adopts alternative QoS configuration information. Alternative QoS policy information for the service data packet set based on the QoS requirement information is generated. The alternative QoS policy information is transmitted to a session management function (SMF) to enable the SMF to configure the alternative QoS policy information for a device that processes the service data packet set.

### CROSS REFERENCE TO RELATED APPLICATION

This application is a bypass continuation application of International Patent Application No. PCT/CN2024/131394 , filed on November 11, 2024, which claims priority to and is based on Chinese Patent Application No. 202311745643.4, filed on December 18, 2023, the disclosures of which are incorporated herein in their entireties by reference.

### FIELD

The present disclosure relates to the field of computers and communication technologies, and in particular, to a quality of service (QoS) processing method, an apparatus, a computer readable storage medium, and a device for a service data packet set.

### BACKGROUND

In a fifth-generation mobile communication technology (5G) and a subsequent evolution system (such as 5G-A and 6G), high-bandwidth interactive services such as cloud gaming, virtual reality (VR), augmented reality (AR), mixed reality (MR), extended reality (XR), cinematic reality (CR), and XR and media services (XRM) are of significance.

These high-bandwidth interactive services not only require a short transmission time limit, but also bring, with the improvement of indicators such as a resolution and a frame rate, a significantly increased amount of data generated by an application layer. Therefore, a data packet content generated by the application layer of such services is transmitted through a series of data packets with a correlation. The series of data packets is called a protocol data unit (PDU) set. For a transmission process of the series of data packets, how to enable effective implementations of transmission control to cope with a challenge of high-bandwidth interactive services to wireless network transmission is a technical problem that needs to be solved urgently.

### SUMMARY

Provided are a quality of service (QoS) processing method and apparatus for a service data packet set, a computer readable storage medium, a device, and a program product, which can implement adjustable QoS processing for the service data packet set based on alternative QoS policy information, thereby improving flexibility of processing the service data packet set during transmission of a service data flow.

Other features and advantages of the present disclosure become apparent through the following detailed descriptions, or are partially learned through practice of the present disclosure.

According to an aspect, an embodiment of the present disclosure provides a quality of service (QoS) processing method for a service data packet set including: obtaining QoS requirement information for a service data flow, the QoS requirement information indicating that a service data packet set in the service data flow adopts alternative QoS configuration information; generating alternative QoS policy information for the service data packet set based on the QoS requirement information; and transmitting the alternative QoS policy information to a session management function (SMF) to enable the SMF to configure the alternative QoS policy information for a device that processes the service data packet set.

According to an aspect, an embodiment of the present disclosure provides QoS processing apparatus for a service data packet set including: at least one memory configured to store program code; and at least one processor configured to read the program code and operate as instructed by the program code, the program code including: an obtaining code configured to cause the at least one of the at least one processor to obtain QoS requirement information for a service data flow, the QoS requirement information indicating that a service data packet set in the service data flow adopts alternative QoS configuration information; a first generating code configured to cause the at least one of the at least one processor to generate alternative QoS policy information for the service data packet set based on the QoS requirement information; and a transmitting code configured to cause the at least one of the at least one processor to transmit the alternative QoS policy information to an SMF to enable the SMF to configure the alternative QoS policy information for a device that processes the service data packet set.

According to an aspect, an embodiment of the present disclosure provides a non-transitory computer-readable storage medium, storing computer code which, when executed by at least one processor, causes the at least one processor to at least: obtain QoS requirement information for a service data flow, the QoS requirement information indicating that a service data packet set in the service data flow adopts alternative QoS configuration information; generate alternative QoS policy information for the service data packet set based on the QoS requirement information; and transmit the alternative QoS policy information to a session management function (SMF) to enable the SMF to configure the alternative QoS policy information for a device that processes the service data packet set.

According to an aspect, an embodiment of the present disclosure provides a quality of service (QoS) processing method for a service data packet set, including: generating QoS requirement information for a service data flow, the QoS requirement information indicating that a service data packet set in the service data flow adopts alternative QoS configuration information; and transmitting the QoS requirement information to a policy control function (PCF) to enable the PCF to generate alternative QoS policy information for the service data packet set based on the QoS requirement information. The QoS requirement information further includes at least one of the following information: first indication information, configured to indicate the alternative QoS configuration information adopted for the service data packet set; or a media content characteristic comprised in the service data flow. The alternative QoS configuration information includes at least one of the following information: a selectable numerical value range of QoS parameters for the service data packet set; and a selectable numerical value of each of the QoS parameters for the service data packet set. The QoS parameters for the service data packet set include at least one of the following parameters: a protocol data unit (PDU) set delay budget (PSDB), a PDU set error rate (PSER), a maximum data burst volume (MDBV), or a path delay variable. The service data flow includes data of a plurality of media types, the plurality of media types including target media types for which data transmission is performed through the service data packet set; and the QoS requirement information includes alternative QoS configuration information corresponding to a service data packet set of each of the target media types. The transmitting the QoS requirement information to a policy control function (PCF) includes: directly transmitting the QoS requirement information to the PCF; transmitting the QoS requirement information to a network exposure function (NEF) to enable the NEF to forward the QoS requirement information to the PCF; or transmitting the QoS requirement information to the PCF by negotiating a service level agreement (SLA) with the PCF.

According to an aspect, an embodiment of the present disclosure provides a QoS processing method for a service data packet set, including: receiving alternative QoS policy information for the service data packet set, the alternative QoS policy information being generated by a PCF based on QoS requirement information of a service data flow, the QoS requirement information indicating that the service data packet set in the service data flow adopts alternative QoS configuration information; detecting QoS parameters of the service data packet set during transmission; and transmitting first notification information to a core network element if the QoS parameters of the service data packet set during the transmission do not match the alternative QoS policy information, to trigger a PDU session modification process. The method includes reselecting, if a part of the QoS parameters of the service data packet set during the transmission does not match the alternative QoS policy information, a QoS parameter for the part of the QoS parameters based on the alternative QoS policy information. The method includes transmitting second notification information to the core network element to notify that the part of the QoS parameters has been reselected.

According to an aspect, an embodiment of the present disclosure provides a QoS processing apparatus for a service data packet set, including: a generating unit, configured to generate QoS requirement information for a service data flow, the QoS requirement information indicating that a service data packet set in the service data flow adopts alternative QoS configuration information; and a transmitting unit, configured to transmit the QoS requirement information to a PCF to enable the PCF to generate alternative QoS policy information for the service data packet set based on the QoS requirement information.

According to an aspect, an embodiment of the present disclosure provides a QoS processing apparatus for a service data packet set, including a receiving unit, configured to receive alternative QoS policy information for the service data packet set, the alternative QoS policy information being generated by a PCF based on QoS requirement information of a service data flow, the QoS requirement information indicating that the service data packet set in the service data flow adopts alternative QoS configuration information; a detecting unit, configured to detect QoS parameters of the service data packet set during transmission; and a processing unit, configured to transmit first notification information to a core network element if the QoS parameters of the service data packet set during the transmission do not match the alternative QoS policy information, to trigger a PDU session modification process.

The foregoing general descriptions and the following detailed descriptions are exemplary and explanatory only, and are not intended to limit the present disclosure.

### BRIEF DESCRIPTION OF DRAWINGS

To describe the technical solutions in the embodiments of the present disclosure more clearly, the following briefly describes the accompanying drawings required for describing the embodiments of the present disclosure. The accompanying drawings in the following description show only some embodiments of the present disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an exemplary system architecture to which a technical solution of an embodiment of the present disclosure is applied;

FIG. 2 is a schematic diagram of a transmission process of a multimedia data packet according to an embodiment of the present disclosure;

FIG. 3 is a flowchart of a quality of service (QoS) processing method for a service data packet set according to an embodiment of the present disclosure;

FIG. 4 is a flowchart of a QoS processing method for a service data packet set according to an embodiment of the present disclosure;

FIG. 5 is a schematic diagram of an architecture of a key network element of a 5^{th}-Generation (5G) network;

FIG. 6 is a flowchart of a QoS processing method for a service data packet set according to an embodiment of the present disclosure;

FIG. 7 is a flowchart of a QoS processing method for a service data packet set according to an embodiment of the present disclosure;

FIG. 8 is a schematic diagram of content included in a protocol data unit (PDU) set aware alternative QoS profile (AQP) according to an embodiment of the present disclosure;

FIG. 9 is a schematic diagram of content included in an alternative QoS rule for a PDU set according to an embodiment of the present disclosure;

FIG. 10 is a flowchart of a QoS processing method for a service data packet set according to an embodiment of the present disclosure;

FIG. 11 is a block diagram of a QoS processing apparatus for a service data packet set according to an embodiment of the present disclosure;

FIG. 12 is a block diagram of a QoS processing apparatus for a service data packet set according to an embodiment of the present disclosure;

FIG. 13 is a block diagram of a QoS processing apparatus for a service data packet set according to an embodiment of the present disclosure;

FIG. 14 is a schematic structural diagram of a computer system of an electronic device configured to implement embodiments of the present disclosure.

### DETAILED DESCRIPTION

Exemplary implementations are now described in a more comprehensive manner with reference to the accompanying drawings. However, the exemplary implementations can be implemented in various forms, and are not to be understood as being limited to these examples. On the contrary, the purpose of providing the implementations is to make the present disclosure more comprehensive and complete, and to fully convey the concept of the exemplary implementations to a person skilled in the art.

In addition, features, structures, or characteristics described in the present disclosure may be combined in one or more embodiments in any proper manner. In the following description, many details are provided to comprehensively understand the embodiments of the present disclosure. However, a person skilled in the art is to be aware that, during implementation of the technical solutions in the present disclosure, not all detailed features in the embodiments need to be used. One or more specific details may be omitted, or another method, unit, apparatus, operation, and the like may be used.

In the embodiments of the present disclosure, the term "module" or "unit" refers to a computer program or a part of the computer program that has a predetermined function, and operates together with another relevant part to achieve a predetermined objective, and may be entirely or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

The block diagrams shown in the accompanying drawings are merely functional entities and do not necessarily correspond to physically independent entities. To be specific, the functional entities may be implemented in a form of software, or in one or more hardware modules or integrated circuits, or in different networks and/or processor apparatuses and/or microcontroller apparatuses.

The flowcharts shown in the accompanying drawings are merely exemplary descriptions. The flowcharts do not need to include all content and operations/steps, and the flowcharts do not need to be performed in the described orders either. For example, some operations/steps may be further divided, while some operations/steps may be merged or partially merged. Therefore, an actual execution order may change according to an actual case.

"A plurality of" mentioned herein means two or more. "And/or" means an association relationship for describing associated objects and represents that three relationships may exist. For example, A and/or B may represent the following three cases: only A exists, both A and B exist, and only B exists. The character "/" generally indicates an "or" relationship between associated objects.

As the 5^{th} Generation (5G) and a subsequent evolution system thereof (such as 5G-Advanced (5G-A) and the 6^{th} Generation (6G)) develop, many multimedia services that require a large data amount and a short latency are widely used. For example, interactive services such as cloud gaming services, virtual reality (VR), augmented reality (AR), mixed reality (MR), extended reality (XR), and cinematic reality (CR) are widely used.

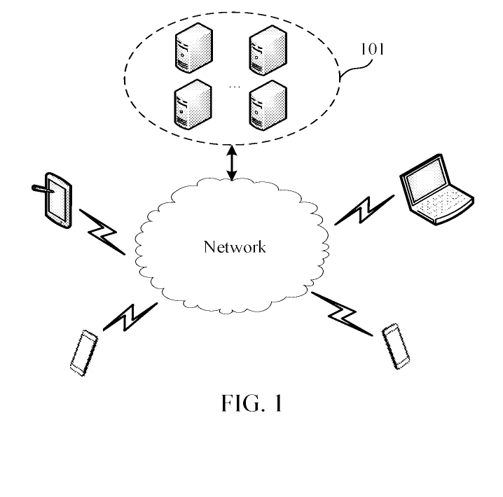

For example, in a cloud gaming scenario shown in FIG. 1, a cloud server 101 is configured to run a cloud game. The cloud server 101 may render a game picture, encode an audio signal and a rendered image, and transmit encoded data to game clients through a network. The game client may be user equipment (UE) with a basic streaming media playback capability, a human-computer interaction capability, a communication capability, and the like, such as a smartphone, a tablet computer, a notebook computer, a desktop computer, a smart television, a smart home appliance, an on-board terminal, or an aircraft. Alternatively, the game client may be an application program running in a terminal device. Specifically, the game client may decode the encoded data transmitted by the cloud server 101 to obtain an analog audio/video signal and play the analog audio/video signal.

FIG. 1 exemplarily represents a system architecture of a cloud game system, and does not limit a specific architecture of the cloud game system. For example, in another embodiment, the cloud game system may further include a background server for scheduling and the like. In addition, the cloud server 101 may be an independent physical server, or may be a server cluster formed by a plurality of physical servers or a distributed system, or may be a cloud server providing basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence platform. The game client and the cloud server 101 may be directly or indirectly connected through wired or wireless communication, which is not limited in the present disclosure.

In the above various multimedia-based interaction service application scenarios, since a multimedia data packet has a large size, it needs to be split into a plurality of data packets for transmission. Specifically, as shown in FIG. 2, using a 5G system as an example, a user plane mainly includes an application server, a user plane function (UPF), a base station (a next generation nodeB, gNB), and a UE. Most multimedia data packets are transmitted in a downlink direction in some typical service scenarios. For example, the multimedia data packets are transmitted from the application server to the UPF, and then to the UE through the gNB. During transmission, a multimedia data packet (an XR data packet is used as an example in FIG. 2) is split at an application layer of the application server, and after split data packets arrive at the UPF from the application server as Internet protocol (IP) packets, the 5G system transmits data sub-packets to a UE side through a PDU session, and the data sub-packets are gradually transmitted from a protocol stack to upper layers at a UE side and recombined to recover the multimedia data packet.

In the system shown in FIG. 2, an L1 layer refers to a physical layer, which is configured to ensure that origin data may be transmitted on various physical media; an L2 layer refers to a data link layer, and the data link layer provides a service to a network layer based on a service provided by the physical layer; an IP layer is a network layer configured to implement data transmission between two end systems; UDP is a user datagram protocol; GTP-U is a GPRS (general packet radio service) tunneling protocol user plane; PHY is an abbreviation of Physical, and is a physical layer; MAC is media access control; RLC is radio link control; PDCP is a packet data convergence protocol; SDAP is a service data adaptation protocol.

As described above, for a multimedia service, such as an XRM service, a frame of a multimedia data packet is split into a plurality of data packets for transmission. A data packet formed by a single multimedia service frame or a group of data packets (GoP) may also have a relatively large number of bytes, which needs to be carried by a series of IP data packets. A specific correlation exists between the IP data packets. Processing the packets based on the correlation can effectively save wireless network bandwidth.

For example, it is assumed that when performing data transmission through a plurality of IP data packets, the plurality of IP data packets may form a PDU set. If some data packets in the PDU set are lost, an entire frame, GoP, or another video part content may not be decoded. Then, the remaining data in the PDU set is also meaningless to a decoding end. If forward error correction (FEC) or another mechanism for the application layer is introduced, and a media application layer has, to an extent, a packet loss recovery capability or a packet loss prevention capability, the remaining data in the PDU set may still be decoded after discarding some messages, indicating that the remaining data in the PDU set is still meaningful for decoding through a receiving end.

In addition, if in a QoS processing mechanism, different PDU sets are distinguished based on a correlation of application layer data packets, processing may continue for a PDU set that has a high rate and may tolerate a certain proportion of a packet error rate (PER) or delay exceedance rate. In other words, a processing mode of a multimedia service may be more flexible. However, in the related art, no reasonable and effective solution has been provided for this situation.

Exactly based on the problem, a technical solution of an embodiment of the present disclosure propose a new QoS processing solution for a service data packet set, such that when processing the service data packet set, adjustable QoS processing for the service data packet set may be implemented based on alternative QoS policy information, thereby improving flexibility of processing the service data packet set during transmission of a service data flow, meeting different requirements of the service data flow, and better coping with a challenge of a high-bandwidth interactive service to wireless network transmission.

Implementation details of the technical solutions of the embodiments of the present disclosure are described in detail below.

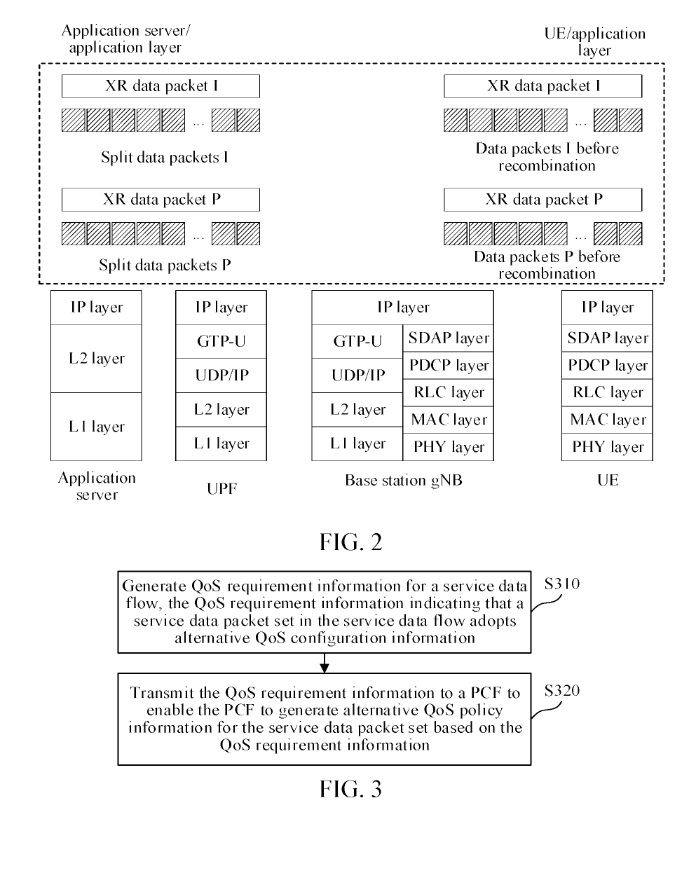

FIG. 3 is a flowchart of a QoS processing method for a service data packet set according to an embodiment of the present disclosure. The QoS processing method for a service data packet set may be performed by an application function (AF), or may also be performed by another network element. Referring to FIG. 3, the QoS processing method for a service data packet set at least includes S310 to S320. The detailed description is as follows.

In S310, QoS requirement information for a service data flow is generated, the QoS requirement information indicating that a service data packet set in the service data flow adopts alternative QoS configuration information.

The service data packet set may be a PDU set. In particular, the service data flow may include a multimedia service data flow, such as a cloud gaming service data flow, a VR service data flow, an AR service data flow, an MR service data flow, an XR service data flow, an XRM service data flow, a CR service data flow, or the like. Since a data packet formed by the single multimedia service frame or GoP may have a relatively large number of bits and need to be split into a series of data packets for carrying. These data packets have a certain correlation, therefore, these data packets having the correlation may be referred to as the PDU set.

Meanwhile, the alternative QoS configuration information may be an alternative QoS profile (an AQP for short), or may be another QoS configuration information that meets requirements. In the present disclosure, the AQP is used as an example. The AQP in the embodiments of the present disclosure is for the service data packet set, and is used for indicating that a QoS configuration of the service data packet set is alternative. In this way, the QoS of the service data packet set may be flexibly controlled to meet different requirements of the service data flow. For example, for some service data packet sets, a certain proportion of a PER or delay exceedance rate may be tolerated, processing may continue through the alternative QoS configuration information, and renegotiation processing on a QoS parameter with a core network is not needed.

In some embodiments, the QoS requirement information may include the alternative QoS configuration information for the service data packet set.

In some embodiments, the alternative QoS configuration information may be a selectable numerical value range of QoS parameters of the service data packet set, such as a numerical value range formed by a most preferred value and a least preferred, but still acceptable value of each of the QoS parameters of the service data packet set.

In some embodiments, the alternative QoS configuration information may be a selectable numerical value of each of the QoS parameters of the service data packet set, such as several (one or more) preferred numerical values of each of the QoS parameters of the service data packet set.

In some embodiments, the alternative QoS configuration information may include a selectable numerical value range of the QoS parameters of the service data packet set, and a selectable numerical value of each of the QoS parameters of the service data packet set. To be specific, in this embodiment, the alternative QoS configuration information may include the selectable numerical value range of the QoS parameters, and may also include the selectable numerical values.

In some embodiments, the QoS parameter for the service data packet set included in the QoS configuration information may be at least one of the following parameters: a PDU set delay budget (PSDB), a PDU set error rate (PSER), a maximum data burst volume (MDBV), or a packet latency variation (PDV).

For example, the alternative QoS configuration information includes a selectable numerical value range of the PSDB of the service data packet set, such as [1 ms, 5 ms].

For example, the alternative QoS configuration information includes a selectable numerical value of the PSDB of the service data packet set, such as 1 ms, 2 ms, 3 ms, 4 ms, and 5 ms.

For example, the alternative QoS configuration information includes a selectable numerical value range of the PSDB of the service data packet set, such as [1 ms, 5 ms], and also, the alternative QoS configuration information includes a selectable numerical value of the PSDB of the service data packet set, such as 1 ms, 2 ms, 3 ms, 4 ms, and 5 ms.

For example, the alternative QoS configuration information includes a selectable numerical value range of the PSER of the service data packet set, such as [0, 5%].

For example, the alternative QoS configuration information includes a selectable numerical value of the PSER of the service data packet set, such as 1%, 2%, 3%, 4%, and 5%.

For example, the alternative QoS configuration information includes a selectable numerical value range of the PSER of the service data packet set, such as [0, 5%], and also, the alternative QoS configuration information includes a selectable numerical value of the PSER of the service data packet set, such as 1%, 2%, 3%, 4%, and 5%.

For example, the alternative QoS configuration information includes a selectable numerical value range of the MDBV of the service data packet set, such as [0, 10 bit].

For example, the alternative QoS configuration information includes a selectable numerical value of the MDBV of the service data packet set, such as 1 bit, 2 bits, 3 bits, 4 bits, and 5 bits.

For example, the alternative QoS configuration information includes a selectable numerical value range of the MDBV of the service data packet set, such as [0, 10 bit], and also, the alternative QoS configuration information includes a selectable numerical value of the MDBV of the service data packet set, such as 1 bit, 2 bits, 3 bits, 4 bits, and 5 bits.

For example, the alternative QoS configuration information includes a selectable numerical value range of the PDV of the service data packet set, such as [0 ms, 1 ms].

For example, the alternative QoS configuration information includes a selectable numerical value of the PDV of the service data packet set, such as 1 ms and 2 ms.

For example, the alternative QoS configuration information includes a selectable numerical value range of the PDV of the service data packet set, such as [0 ms, 1 ms], and also, the alternative QoS configuration information includes a selectable numerical value of the PDV of the service data packet set, such as 1 ms and 2 ms.

In some embodiments, the QoS requirement information may include first indication information. The first indication information is configured to indicate the alternative QoS configuration information adopted for the service data packet set. To be specific, in this embodiment, the first indication information indicates that the alternative QoS configuration information may be adopted for the service data packet set, so that based on the first indication information, a policy control function (PCF) can determine corresponding alternative QoS policy information when the alternative QoS configuration information is adopted.

In some embodiments, the QoS requirement information may include a media content characteristic included in the service data flow. To be specific, in this embodiment, the QoS requirement information may indicate the media content characteristic in the service data flow, so that the PCF can determine the corresponding alternative QoS policy information when the alternative QoS configuration information is adopted based on the media content characteristic.

In some embodiments, the media content characteristic may be used to characterize a media type. For example, based on the media content characteristic, it can be determined that the media type is audio, video, or haptic information. In this case, the media content characteristic may reflect a QoS requirement of a corresponding media type to a certain extent. For example, since the haptic information has a higher requirement for real-time performance and interactivity, the haptic information has a higher requirement for a delay than audio and video content. Therefore, the PCF may determine the media type based on the media content characteristic, and further determine the alternative QoS policy information when adopting the alternative QoS configuration information.

The media content characteristic may also be used to characterize a service type of a media. For example, it can be determined based on the media content characteristic that the service type of the media is a cloud gaming service, a remote driving service, a mail transmission service, or the like. In this case, the media content characteristic may also reflect a QoS requirement of a corresponding service type to a certain extent. For example, since the cloud gaming service and the remote driving service have a higher requirement for the real-time performance than the mail transmission service, the cloud gaming service and the remote driving service have a higher requirement for the delay than the mail transmission service. Therefore, the PCF may determine the service type based on the media content characteristic, and further determine the alternative QoS policy information when adopting the alternative QoS configuration information.

The QoS requirement information further includes at least one of the following information: the first indication information, or a media content characteristic included in a service data flow.

In some embodiments, the service data flow may include data of a plurality of media types, such as an audio type, a video type, and a haptic type. Therefore, for the data of these media types, it may be selected whether data transmission is performed through the service data packet set. If the data transmission is performed through the service data packet set, the alternative QoS configuration information may be respectively generated for service data packet sets of various media types.

In other words, if the plurality of media types in the service data flow include target media types for which data transmission is performed through the service data packet set, the QoS requirement information includes alternative QoS configuration information corresponding to a service data packet set of each of the target media types. In this way, QoS control may be performed respectively for service data packet sets of different media types. For example, assuming that the service data flow includes audio data and video data, for the two types of data, data transmission may be performed through the service data packet set. Based on the above, the QoS requirement information includes: alternative QoS configuration information corresponding to a service data packet set of the audio data, and alternative QoS configuration information corresponding to a service data packet set of the video data, so that the QoS control can be respectively performed for the service data packet sets of the audio data and the video data.

Still referring to FIG. 3, in S320, the QoS requirement information is transmitted to a PCF to enable the PCF to generate alternative QoS policy information for the service data packet set based on the QoS requirement information.

In some embodiments, when the QoS requirement information is transmitted to the PCF, the QoS requirement information may be directly transmitted to the PCF. Alternatively, the QoS requirement information may also be transmitted to a network exposure function (NEF), and then the NEF forwards the QoS requirement information to the PCF. Alternatively, the QoS requirement information may also be transmitted to the PCF by negotiating a service level agreement (SLA) with the PCF.

The technical solutions of the embodiments of the present disclosure are described above in terms of an AF. The implementation details of the technical solutions of the embodiments of the present disclosure are further described below in terms of the PCF with reference to FIG. 4.

FIG. 4 is a flowchart of a QoS processing method for a service data packet set according to an embodiment of the present disclosure. The QoS processing method for a service data packet set may be executed by the PCF or may also be executed by another network element. Referring to FIG. 4, the QoS processing method for a service data packet set at least includes S410 to S430. The detailed description is as follows.

In S410, QoS requirement information for a service data flow is obtained, the QoS requirement information indicating that a service data packet set in the service data flow adopts alternative QoS configuration information.

In some embodiments, the service data packet set may be a PDU set, and data packets in the PDU set have a certain correlation. The alternative QoS configuration information is the AQP. The AQP in the embodiments of the present disclosure is for the service data packet set, and is used for indicating that a QoS requirement of the service data packet set is alternative. In this way, the QoS of the service data packet set may be flexibly controlled to meet different requirements of the service data flow. For example, for some service data packet sets, a certain proportion of a PER or delay exceedance rate may be tolerated, processing may continue through the alternative QoS configuration information, and renegotiation processing on a QoS parameter with a core network is not needed.

For content included in the QoS requirement information, reference may be made to the technical solutions of the foregoing embodiments. Details are not described again.

In S420, alternative QoS policy information for the service data packet set is generated based on the QoS requirement information.

In some embodiments, the alternative QoS policy information may include second indication information. The second indication information is configured for indicating whether to map data of different media types included in the service data flow to different QoS flows. For example, the service data flow may include data of a plurality of media types, such as an audio type, a video type, and a haptic type. The QoS policy information may include the second indication information. The second indication information is configured to indicate whether to map the data of these different media types to different QoS flows. To be specific, the data of the different media types uses separate QoS flows, respectively.

The second indication information may be direct indication information (or an explicit indication), or may be indirect indication (or implicit indication) information. For example, the alternative QoS policy information may directly include indication information for mapping data of different media types included in the service data flow to different QoS flows, or include indication information for not mapping data of different media types included in the service data flow to a same QoS flow (for example, mapping data of different media types included in the service data flow to a same QoS flow).

In some embodiments, the alternative QoS policy information may include third indication information. The third indication information is configured to indicate whether to map the data of different media types included in the service data flow to the same QoS flow. To be specific, the data of different media types in the service data flow uses the same QoS flow.

The third indication information may be direct indication information (or an explicit indication), or may be indirect indication (or implicit indication) information. For example, the alternative QoS policy information may directly include indication information for mapping the data of different media types included in the service data flow to the same QoS flow, or include indication information for not mapping the data of the different media types included in the service data flow to different QoS flows.

In some embodiments, the alternative QoS policy information may include fourth indication information. The fourth indication information is configured to indicate whether importance of the different media types is indicated through importance information of the service data packet set if the data of the different media types included in the service data flow is mapped to the different QoS flows.

The fourth indication information may be direct indication information (or an explicit indication), or may be indirect indication (or implicit indication) information. For example, the alternative QoS policy information may directly, when the data of the different media types included in the service data flow is mapped to the different QoS flows, indicate importance of the different media types through importance information (i.e., PDU set important) of the service data packet set.

If the importance of the different media types is indicated, QoS of a service data packet of a high-priority media type may be preferentially ensured during data transmission.

In some embodiments, the alternative QoS policy information may include fifth indication information. The fifth indication information is configured to indicate that if the data of the different media types included in the service data flow is mapped to the same QoS flow, the alternative QoS policy information representing an integrated policy for the same QoS flow. To be specific, the alternative QoS policy information is for data packets of different media types carried in the same QoS flow.

In some embodiments, the alternative QoS policy information may also include a combination of two or more pieces of information of the second indication information, the third indication information, the fourth indication information, and the fifth indication information.

In some embodiments, a process of generating the alternative QoS policy information for the service data packet set based on the QoS requirement information may include that, if the QoS requirement information includes alternative QoS configuration information respectively corresponding to service data packet sets of different media types and the data of the different media types needs to be mapped to the same QoS flow, the integrated policy for the same QoS flow may be generated based on the alternative QoS configuration information respectively corresponding to the service data packet sets of the different media types. To be specific, in this embodiment, if the data of different media types is mapped to the same QoS flow, alternative QoS configuration information respectively corresponding to the service data packet sets of these media types may be integrated to generate an integrated policy information when generating QoS policy information.

In some embodiments, if the alternative QoS configuration information includes bandwidth requirement information, bandwidth requirement information of the different media types may be superimposed to generate an integrated policy for the bandwidth requirement information.

In some embodiments, if the alternative QoS configuration information includes PSDR requirement information, an integrated policy for the PSDR requirement information may be generated based on a minimum value of PSDR requirements in the different media types. This is because when selecting the minimum value of the PSDR requirements in the different media types, PSDR requirements of service data packet sets of all media types may be satisfied.

In some embodiments, if the alternative QoS configuration information includes PSER requirement information, an integrated policy for the PSER requirement information may be generated based on a minimum value of PSER requirements in the different media types. This is because when selecting the minimum value of the PSER requirements in the different media types, PSER requirements of service data packet sets of all media types may be satisfied.

In some embodiments, if the alternative QoS configuration information includes MDBV requirement information, an integrated policy for the MDBV requirement information may be generated based on a maximum value of MDBV requirements in the different media types. This is because when selecting the maximum value of the MDBV requirements in the different media types, MDBV requirements of service data packet sets of all media types may be satisfied. Alternatively, MDBV requirement information in the different media types may also be superimposed to generate an integrated policy for the MDBV requirement information.

In some embodiments, if the alternative QoS configuration information includes PDV requirement information, an integrated policy for the PDV requirement information may be generated based on a minimum value of PDV requirements in the different media types. This is because when selecting the minimum value of the PDV requirements in the different media types, PDV requirements of service data packet sets of all media types may be satisfied.

In some embodiments, the process of generating the alternative QoS policy information for the service data packet set based on the QoS requirement information may include that, if the data of the different media types included in the service data flow needs to be mapped to the different QoS flows, alternative QoS policy information may be respectively generated for service data packet sets in the different QoS flows. The technical solution of this embodiment enables, when the data of the different media types is mapped to the different QoS flows, QoS control to be performed respectively on different QoS flows based on the alternative QoS policy information.

In some embodiments, the alternative QoS policy information includes at least one of the following information: a selectable numerical value range of QoS parameters of the service data packet set, or a selectable numerical value of each of the QoS parameters of the service data packet set.

In some embodiments, the alternative QoS policy information may include the selectable numerical value range of the QoS parameters of the service data packet set, such as a numerical value range formed by a most preferred value and a least preferred, but still acceptable value of each of the QoS parameters of the service data packet set.

In some embodiments, the alternative QoS policy information may also include the selectable numerical value of each of the QoS parameters of the service data packet set, such as several (one or more) preferred numerical values of each of the QoS parameters of the service data packet set.

In some embodiments, the alternative QoS policy information may also include the selectable numerical value range of the QoS parameters of the service data packet set, and the selectable numerical value of each of the QoS parameters of the service data packet set. To be specific, in this embodiment, the alternative QoS policy information may include the selectable numerical value range of the QoS parameters, and may also include the selectable numerical value.

In some embodiments, a QoS parameter for a service data packet set included in the QoS policy information may be at least one of the following parameters: the PSDB, the PSER, the MDBV, or the PDV.

In some embodiments, the process of generating the alternative QoS policy information for the service data packet set based on the QoS requirement information may include generating the alternative QoS policy information associated with a UE and for the service data packet set based on the QoS requirement information and subscription information of the UE for processing the service data packet set.

In some embodiments, the generating the alternative QoS policy information associated with the UE and for the service data packet set based on the QoS requirement information and the subscription information of the UE for processing the service data packet set includes: determining a priority of the UE based on subscription information of the UE; and generating the alternative QoS policy information associated with the UE and for the service data packet set based on the QoS requirement information and the priority of the UE. For example, if it is determined based on the subscription information of the UE that the priority of the UE is relatively high (such as, a corresponding account is a member account, or a processed service type has a high requirement for a delay), generated alternative QoS policy information for a service data packet set needs to ensure that the UE with the relatively high priority has better quality of service.

In some embodiments, the process of generating the alternative QoS policy information for the service data packet set based on the QoS requirement information may also include generating the alternative QoS policy information for the service data packet set based on the QoS requirement information and an SLA negotiated with an AF.

In some embodiments, the generating the alternative QoS policy information for the service data packet set based on the QoS requirement information and the SLA negotiated with the AF includes: determining the priority of the UE based on the SLA; and generating the alternative QoS policy information for the service data packet set based on the QoS requirement information and the priority of the UE. For example, if it is determined based on the SLA that priorities of some UEs are relatively high (such as corresponding accounts are member accounts), generated alternative QoS policy information for a service data packet set needs to ensure that the UEs with the relatively high priorities have better quality of service.

Still referring to FIG. 4, in S430, the alternative QoS policy information is transmitted to a session management function (SMF), enabling the SMF to configure the alternative QoS policy information for a device that processes the service data packet set.

In some embodiments, the SMF may transmit the alternative QoS policy information for the service data packet set to a UPF, a gNB, and a UE.

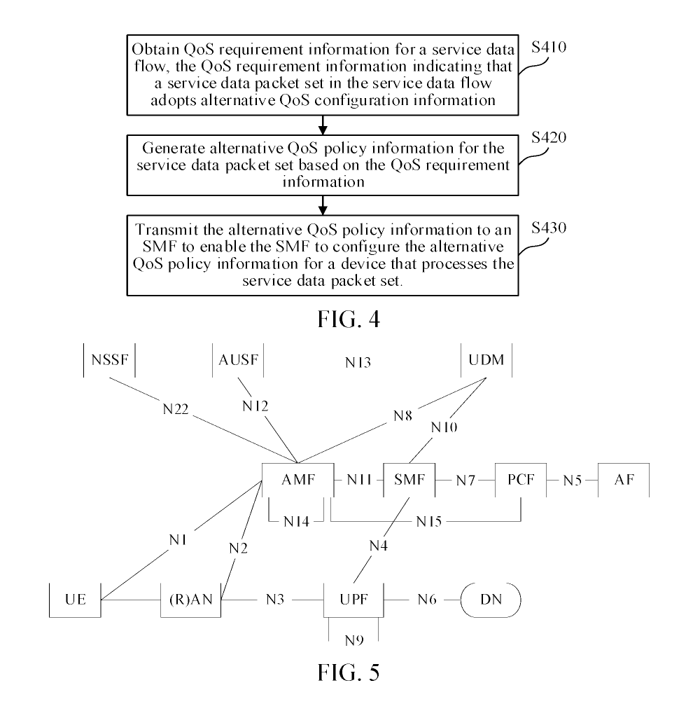

Specifically, a 5G system is used as an example. FIG. 5 shows a key network element architecture of a 5G network defined by the 3^{rd} generation partnership project (3GPP) organization. An access and mobility management function (AMF), an SMF, a UPF, a PCF, a network slice selection function (NSSF), an authentication server function (AUSF), a unified data management (UDM), and the like are core network elements of the 5G network. The UE may be a 5G terminal, such as a mobile phone or a tablet computer. A radio access network (RAN) may be a 5G base station. A DN means a data network, namely, a service server accessed by the UE.

The AMF is responsible for terminating an N2 interface of a control plane of the base station, and implementing encoding and decoding of a next generation application protocol (NGAP) based on a stream control transmission protocol (SCTP). The base station and the AMF transmit an application-layer NGAP protocol through the SCTP transmission layer protocol, and non-access stratum (NAS) signaling data of the UE is carried in the NGAP. The AMF is also responsible for terminating an N1 interface of the UE to implement encryption and integrity protection for the NAS, and is responsible for functions such as UE access authentication, authorization management, registration, connection, reachability, and mobility management, and is also responsible for transparent transmission of a session management message between the UE and the SMF.

In addition, interaction between the RAN and the UPF may be performed through an N3 interface; interaction between the UPFs is performed through an N9 interface; interaction between the UPF and the SMF is performed through an N4 interface; interaction between the UPF and the DN is performed through an N6 interface; interaction between the SMF and the AMF is performed through an N11 interface; interaction between the SMF and the PCF is performed through an N7 interface; interaction between the SMF and the UDM is performed through an N10 interface; interaction between the PCF and the AF is performed through an N5 interface; interaction between the AMFs may be performed through an N14 interface; interaction between the AMF and the PCF is performed through an N15 interface; interaction between the AMF and the UDM is performed through an N8 interface; interaction between the AMF and the NSSF is performed through an N22 interface; interaction between the AMF and the AUSF is performed through an N12 interface; and interaction between the AUSF and the UDM is performed through an N13 interface.

Based on the system architecture shown in FIG. 5, the SMF may configure the alternative QoS policy information for the service data packet set for the UPF through the N4 interface. Moreover, the alternative QoS policy information for the service data packet set is configured for the RAN through a connection of the AMF, and the alternative QoS policy information for the service data packet set is configured for the UE through a connection of the AMF + the NAS.

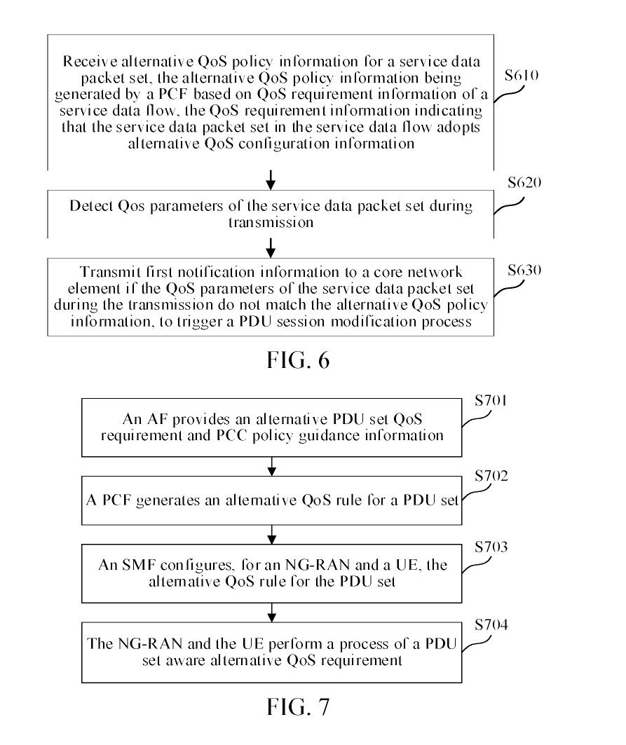

The technical solutions of the embodiments of the present disclosure are described above in terms of the AF and the PCF, respectively. The implementation details of the technical solutions of the embodiments of the present disclosure are further described below in terms of an access network device with reference to FIG. 6.

FIG. 6 is a flowchart of a QoS processing method for a service data packet set according to an embodiment of the present disclosure. The QoS processing method for a service data packet set may be performed by an access network device (such as the UE or a base station), or may also be performed by another device. Referring to FIG. 6, the QoS processing method for a service data packet set at least includes S610 to S630. The detailed description is as follows.

In S610, the alternative QoS policy information for the service data packet set is received, the alternative QoS policy information being generated by the PCF based on QoS requirement information of a service data flow, and the QoS requirement information indicating that the alternative QoS configuration information is adopted for a service data packet set in the service data flow.

In some embodiments, the service data packet set may be a PDU set, and data packets in the PDU set have a certain correlation. The alternative QoS configuration information is the AQP. The AQP in the embodiments of the present disclosure is for the service data packet set, and is used to indicate that a QoS requirement of the service data packet set is alternative. In this way, the QoS of the service data packet set may be flexibly controlled to meet different requirements of the service data flow. For example, for some service data packet sets, a certain proportion of a PER or delay exceedance rate may be tolerated, processing may continue through the alternative QoS configuration information, and renegotiation processing on a QoS parameter with a core network is not needed.

For content included in the QoS requirement information and the process of generating the QoS policy information, reference may be made to the technical solutions of the foregoing embodiments. Details are not described again.

In S620, QoS parameters of the service data packet set during transmission is detected.

In some embodiments, detecting the QoS parameter of the service data packet set during transmission may be detecting at least one of the following parameters: the PSDB, the PSER, the MDBV, and the PDV.

In S630, first notification information is transmitted to a core network element if the QoS parameters of the service data packet set during the transmission do not match the alternative QoS policy information in order to trigger a PDU session modification process.

In some embodiments, if a QoS parameter of the service data packet set cannot meet a requirement during transmission, a QoS parameter may be reselected based on a range indicated in the alternative QoS policy information. In this case, interaction with a core network does not need to trigger a PDU session modification process, but second notification information may be transmitted to the core network to notify that the QoS parameter is changed. In other words, if a part of QoS parameters of the service data packet set during transmission does not match the alternative QoS policy information, a QoS parameter is reselected for the part of the QoS parameters based on the alternative QoS policy information. In some embodiments, second notification information may be transmitted to the core network element in order to notify that a portion of the QoS parameter has been reselected. If a QoS parameter of the service data packet set during transmission exceeds a range indicated in the alternative QoS policy information, it indicates that a QoS parameter of the service data packet set during transmission does not match the alternative QoS policy information. Further, the first notification information may be transmitted to the core network element in order to trigger the PDU session modification process to update the QoS requirement information.

The technical solutions of the embodiments of the present disclosure mainly introduce an alternative QoS mechanism for a service data packet set (i.e., a PDU set). In this way, an adaptive selection of a QoS profile may be performed at a next generation radio access network (NG-RAN) node in order to implement adjustable QoS processing for the PDU set, and meet different requirements of a service data flow.

Specifically, as shown in FIG. 7, a QoS processing method for a service data packet set according to an embodiment of the present disclosure includes the following operations.

In S701, an AF provides a PDU set QoS requirement and policy control and charging (PCC) policy guidance information.

In some embodiments, the AF may provide an alternative QoS requirement for a PDU set, which may be referred to as an AQP mechanism aware of a PDU set (i.e., a PDU set aware AQP), and the AF may provide a fine-grained alternative QoS requirement.

Specifically, if a media service flow includes different media types (such as an audio type, a video type, and a haptic type), a PDU set mechanism may be started or may not be started for these media types. To be specific, it may be selected that whether data transmission is performed through the PDU set.

If the PDU set mechanism is started for a plurality of media types, the AF may indicate that the PDU set aware AQP is respectively supported by different media types. If the PDU set mechanism is not started for some media types, the AF may provide the PDU set aware AQP for a service flow for which the PDU set mechanism is started, and provide another QoS requirement for a service flow for which the PDU set mechanism is not started.

The QoS requirement provided for the service flow for which the PDU set mechanism is not started may include a QoS parameter for a data packet, such as a PER and a data packet delay budget (PDB). The PDU set aware AQP provided for the service flow for which the PDU set mechanism is started may include a QoS parameter for the PDU set, such as the PSDB, the PSER, the MDBV, and the PDV.

In some embodiments, the PDU set aware AQP provided for the service flow for which the PDU set mechanism is started may also include a QoS parameter for a data packet. In this case, a QoS requirement for a data packet in an existing standard protocol is reused. To be specific, the QoS parameter for the PDU set is added to the QoS requirement. Certainly, a brand-new QoS requirement for a PDU set may also be used to include QoS parameter information for the PDU set.

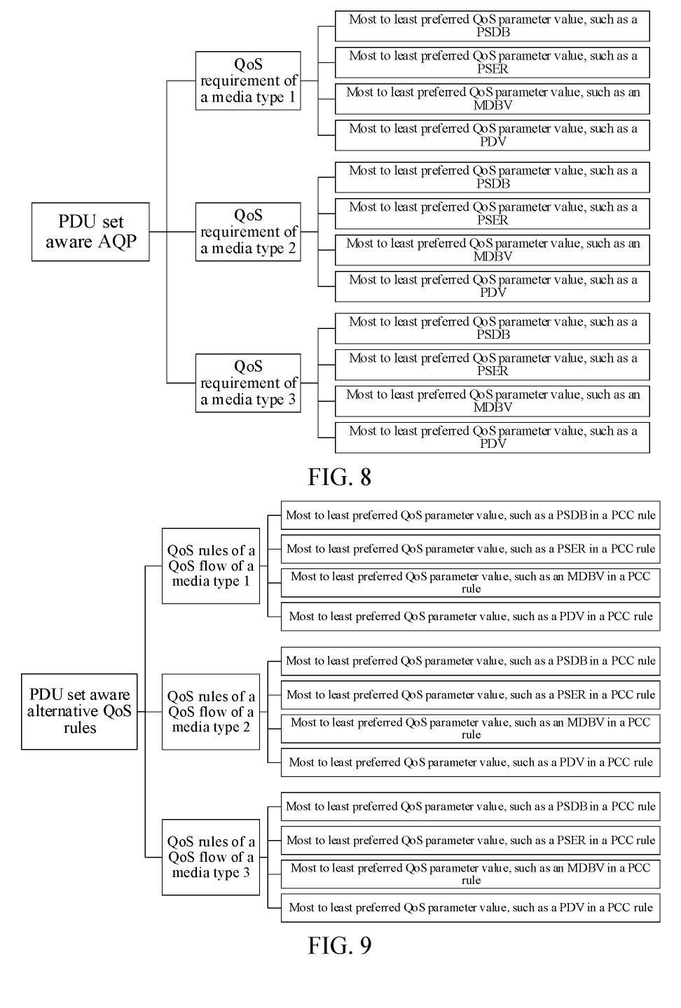

In some embodiments, the alternative QoS requirement and PCC policy guidance information provided by the AF for the PDU set are not PCC rules. Therefore, description may be made in terms of service requirements without needing to provide each parameter of the PCC rules. Content of an example PDU set aware AQP is shown in FIG. 8. Using an exam in which a media service flow includes 3 media types, the PDU set aware AQP includes QoS requirements for each of the media types (i.e., a QoS requirement of a media type 1, a QoS requirement of a media type 2, and a QoS requirement of a media type 3). The QoS requirement of each media type includes most to least preferred QoS parameter values, but still acceptable for the QoS parameters (such as the PSDB, the PSER, the MDBV, and the PDV).

In some embodiments, to reduce an amount of information interacted between the AF and a 5G Core (5GC, namely, a 5G core network), the AF and the 5GC may also embody the PDU set aware AQP by negotiating an SLA. In this case, the SLA may include alternative QoS parameter ranges for different media types.

In S702, a PCF generates an alternative QoS rule for a PDU set.

In some embodiments, after the AF transmits an alternative QoS requirement for a PDU set (i.e., the PDU set aware AQP) to the PCF, or transmits it to the PCF through an NEF, or informs the PCF through an SLA negotiation, the PCF may generate PDU set aware alternative QoS rules (i.e., an alternative QoS policy/rule for the PDU set) based on user subscription information or an SLA with the AF. The generated QoS rules include, but are not limited to, the following information:

whether data of different media types in a media service flow is mapped to different QoS flows; if so, whether importance of different media types is indicated through PDU set importance; and if the data of different media types in the media service flow is mapped to the same QoS flow, configured PDU set aware QoS rules are integrated QoS rules for a plurality of media types.

In some embodiments, if the data of the different media types in the media service flow is mapped to the same QoS flow, and the configured PDU set aware QoS rules are the integrated QoS rules for a plurality of media types, even if the PDU set aware AQP provided by the AF distinguishes media types, the PCF may still generate integrated QoS rules based on requirements of different media types.

In some embodiments, when generating the integrated QoS rules, the PCF may superimpose bandwidth requirements of various media types in order to generate an integrated requirement for bandwidth.

In some embodiments, the PCF may also superimpose the bandwidth requirements of the various media types for an integrated requirement for the MDBV. Alternatively, a maximum value of MDBV requirements of various media types may also be used as the integrated requirement for the MDBV.

In some embodiments, the PCF may comprehensively consider delay requirements (i.e., the PSDB) of various media types, so as to take a minimum value of most preferred delay requirements of all media types as an integrated most preferred delay value, and take a minimum value of least preferred, but acceptable delay values of all media types as an integrated least preferred delay value.

In some embodiments, the PCF may comprehensively consider PSERs of various media types, so as to take a minimum value of most preferred PSERs of all media types as an integrated most preferred PSER value, and take a minimum value of least preferred, but acceptable PSER values of all media types as an integrated least preferred PSER value.

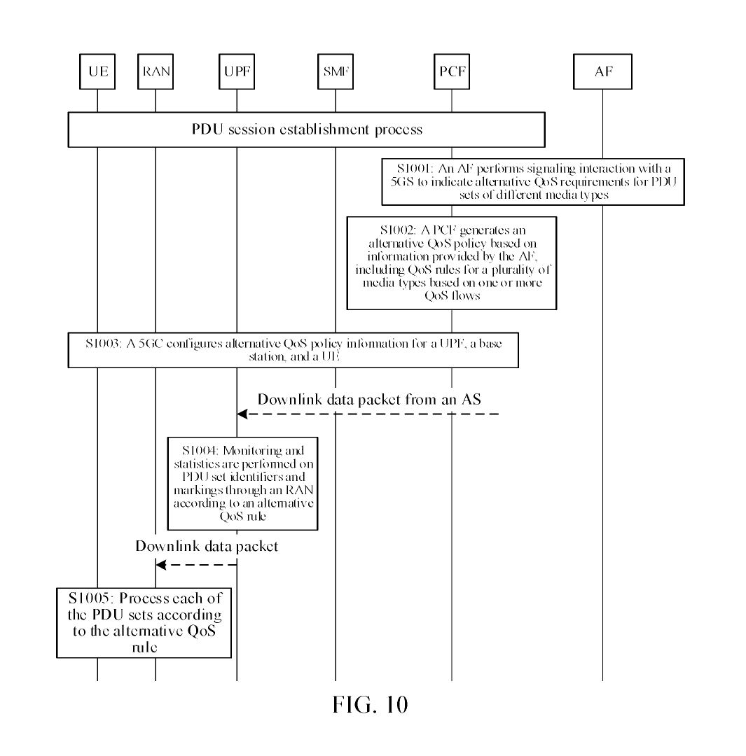

In some embodiments, if data of different media types are mapped to different QoS flows, the configured PDU set aware alternative QoS rules may be generated respectively for the different media types. To be specific, respective QoS rules are for these QoS flows, and the QoS rule includes an alternative PDU set QoS parameter. An example of content included in a QoS rule is shown in FIG. 9. Using an example in which a media service flow includes 3 media types, the PDU set aware alternative QoS rules include QoS rules for QoS flows of the media types (i.e., QoS rules of a QoS flow of a media type 1, QoS rules of a QoS flow of a media type 2, and QoS rules of a QoS flow of a media type 3). The QoS rules of the QoS flow of each media type include most to least preferred, but still acceptable, QoS parameter values for QoS parameters (such as the PSDB, the PSER, the MDBV, and the PDV).

In S703, an SMF configures, for an NG-RAN and a UE, the alternative QoS rule for the PDU set.

In some embodiments, after the PCF generates the PDU set aware alternative QoS rule, the PCF transmits it to the SMF. Then, the SMF configures the QoS rules for the UPF through the N4 interface, where the QoS rules include alternative QoS rules for QoS flows of different media types.

Meanwhile, the SMF configures the PDU set aware alternative QoS rule for the NG-RAN through a connection of the AMF, and the SMF configures the PDU set aware alternative QoS rule for the UE through a connection of the AMF + the NAS.

In S704, the NG-RAN and the UE perform a process of a PDU set aware alternative QoS requirement.

In some embodiments, the NG-RAN and the UE perform data transmission on a Uu interface based on a PDU set aware alternative QoS rule configured by the 5GC. Based on end-to-end QoS monitoring only for an air interface, the NG-RAN may dynamically observe whether a parameter such as the PSDB, the PSER, and the PDV has exceeded a range of the PDU set aware QoS requirement. If so, a PDU session modification or another process is triggered to notify the 5GC and the AF to take a corresponding action.

The technical solution of the embodiments of the present disclosure is described in detail below with reference to FIG. 10 by using an example, which specifically includes the following operations:

In S1001, after establishment of a PDU session is completed, an AF performs signaling interaction with a 5G system (a 5GS) to indicate alternative QoS requirements for PDU sets of different media types.

In S1002, a PCF generates an alternative QoS policy based on information provided by the AF, including QoS rules for a plurality of media types based on one or more QoS flows.

For example, if data of different media types is mapped to the same QoS flow, the PCF may generate integrated QoS rules based on requirements of different media types. If the data of the different media types is mapped to different QoS flows, the PCF may generate PDU set aware alternative QoS rules respectively for the different media types.

In S1003, the 5GC configures alternative QoS policy information for a UPF, a base station, and a UE.

In some embodiments, after generating the PDU set aware alternative QoS rules, the PCF transmits the rules to the SMF. The SMF configures the rules for the UPF through an N4 interface, configures the rules for the NG-RAN through an AMF, and configures the rules for the UE through a connection of the AMF + the NAS.

In S1004, monitoring and statistics are performed on PDU set identifiers and markings through an RAN according to an alternative QoS rule.

In S1005, each of the PDU set is processed according to the alternative QoS rule.

For example, if it is detected that a parameter, such as the PSDB, the PSER, and the PDV, has exceeded a range of a PDU set aware QoS requirement, notification information is transmitted to a core network to trigger a PDU session modification or another process.

In summary, the technical solutions of the embodiments of the present disclosure mainly introduce the PDU set aware AQP mechanism for a PDU set of a multimedia service, such as XR. When the AF provides a fine-grained QoS requirement based on a media type to the 5GC, it indicates an alternative PDU set QoS requirement (including an alternative PDU set QoS parameter, or the like). After the 5GC and an NG-RAN node perform PCC policy generation and establishment of a PDU session and a QoS flow in a core network, adaptive selection of a QoS profile is performed at the NG-RAN node to implement adjustable QoS processing for the PDU set, thereby meeting different requirements of a service data flow.

Apparatus embodiments of the present disclosure are described below, which may be configured to perform the QoS processing method for a service data packet set in the foregoing embodiments of the present disclosure. For details not disclosed in the apparatus embodiments of the present disclosure, reference is made to the foregoing embodiments of the QoS processing method for a service data packet set of the present disclosure.

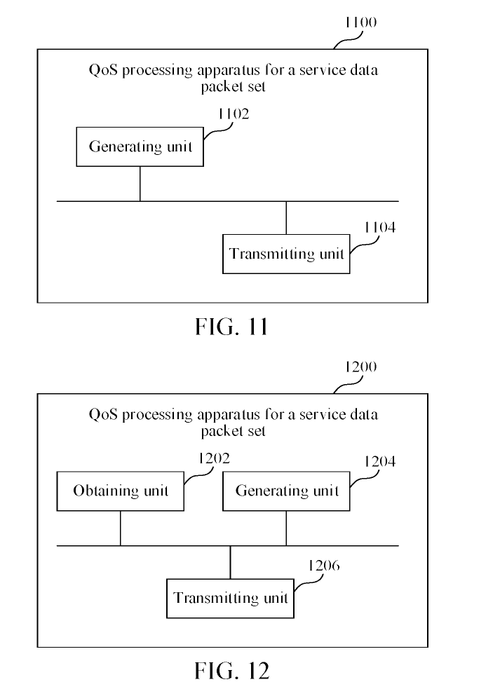

FIG. 11 is a block diagram of a QoS processing apparatus for a service data packet set according to an embodiment of the present disclosure. The QoS processing apparatus for a service data packet set may be applied to an AF or another network element.

Referring to FIG. 11, a QoS processing apparatus 1100 for a service data packet set according to an embodiment of the present disclosure includes a generating unit 1102 and a transmitting unit 1104.

The generating unit 1102 is configured to generate QoS requirement information for a service data flow, the QoS requirement information indicating that a service data packet set in the service data flow adopts alternative QoS configuration information. The transmitting unit 1104 is configured to transmit the QoS requirement information to a PCF in order to enable the PCF to generate alternative QoS policy information for the service data packet set based on the QoS requirement information.

In some embodiments of the present disclosure, based on the above solutions, the QoS requirement information further includes at least one of the following information: first indication information configured to indicate alternative QoS configuration information adopted for the service data packet set; and a media content characteristic included in the service data flow.

In some embodiments of the present disclosure, based on the above solutions, the alternative QoS configuration information includes at least one of the following information: a selectable numerical value range of QoS parameters for the service data packet set; or a selectable numerical value of each of the QoS parameters for the service data packet set.

In some embodiments of the present disclosure, based on the above solutions, the QoS parameter for the service data packet set includes at least one of the following parameters: a PSDB, a PSER, a MDBV, or a path delay variable.

In some embodiments of the present disclosure, based on the above solutions, the service data flow includes data of a plurality of media types, the plurality of media types including target media types for which data transmission is performed through the service data packet set.

The QoS requirement information includes alternative QoS configuration information corresponding to a service data packet set of each of the target media types.

In some embodiments of the present disclosure, based on the above solutions, the transmitting unit 1104 is configured to directly transmit the QoS requirement information to the PCF;

transmit the QoS requirement information to an NEF to enable the NEF to forward the QoS requirement information to the PCF; or

transmit the QoS requirement information to the PCF by negotiating an SLA with the PCF.

FIG. 12 is a block diagram of a QoS processing apparatus for a service data packet set according to an embodiment of the present disclosure. The QoS processing apparatus for a service data packet set may be applied to the PCF or another network element.

Referring to FIG. 12, a QoS processing apparatus 1200 for a service data packet set according to an embodiment of the present disclosure includes: an obtaining unit 1202, a generating unit 1204, and a transmitting unit 1206.

The obtaining unit 1202 is configured to obtain QoS requirement information for a service data flow, the QoS requirement information indicating that a service data packet set in the service data flow adopts alternative QoS configuration information. The generating unit 1204 is configured to generate alternative QoS policy information for the service data packet set based on the QoS requirement information. The transmitting unit 1206 is configured to transmit the alternative QoS policy information to an SMF in order to enable the SMF to configure the alternative QoS policy information for a device that processes the service data packet set.

In some embodiments of the present disclosure, based on the above solutions, the alternative QoS policy information includes at least one of the following information:

second indication information configured to indicate whether to map data of different media types included in the service data flow to different QoS flows;

third indication information configured to indicate whether to map the data of different media types included in the service data flow to the same QoS flow;

fourth indication information configured to indicate whether importance of the different media types is indicated through importance information of the service data packet set if the data of the different media types included in the service data flow is mapped to the different QoS flows; and

fifth indication information configured to indicate that if the data of the different media types included in the service data flow is mapped to the same QoS flow, the alternative QoS policy information representing an integrated policy for the same QoS flow.

In some embodiments of the present disclosure, based on the above solutions, the generating unit 1204 is configured to generate, if the QoS requirement information includes alternative QoS configuration information respectively corresponding to service data packet sets of different media types and the data of the different media types needs to be mapped to the same QoS flow, the integrated policy for the same QoS flow based on the alternative QoS configuration information respectively corresponding to the service data packet sets of the different media types.

In some embodiments of the present disclosure, based on the above solutions, the generating unit 1204 being configured to generate an integrated policy for the same QoS flow based on the alternative QoS configuration information respectively corresponding to the service data packet sets of the different media types includes:

superimposing, if the alternative QoS configuration information includes bandwidth requirement information, bandwidth requirement information of the different media types to generate an integrated policy for the bandwidth requirement information;

generating, if the alternative QoS configuration information includes PSDB requirement information, an integrated policy for the PSDB requirement information based on a minimum value of PSDB requirements in the different media types;

generating, if the alternative QoS configuration information includes PSER requirement information, an integrated policy for the PSER requirement information based on a minimum value of PSER requirements in the different media types;

generating, if the alternative QoS configuration information includes MDBV requirement information, an integrated policy for the MDBV requirement information based on a maximum value of MDBV requirements for the different media types, or superimposing the MDBV requirement information in the different media types to generate an integrated policy for the MDBV requirement information; and

generating, if the alternative QoS configuration information includes packet delay variation (PDV) requirement information, an integrated policy for the PDV requirement information based on a minimum value of PDV requirements in the different media types.

In some embodiments of the present disclosure, based on the above solutions, the generating unit 1204 is configured to generate, if the data of the different media types included in the service data flow needs to be mapped to the different QoS flows, alternative QoS policy information for service data packet sets in the different QoS flows.

In some embodiments of the present disclosure, based on the above solutions, the alternative QoS policy information includes at least one of the following information: a selectable numerical value range of QoS parameters of the service data packet set, or a selectable numerical value of each of the QoS parameters of the service data packet set.

In some embodiments of the present disclosure, based on the above solutions, the generating unit 1204 is configured to generate, based on the QoS requirement information and subscription information of a user equipment (UE) for processing the service data packet set, the alternative QoS policy information associated with the UE and for the service data packet set.

In some embodiments of the present disclosure, based on the above solutions, the generating unit 1204 is configured to determine a priority of the UE based on the subscription information of the UE; and generate, based on the QoS requirement information and the priority of the UE, the alternative QoS policy information associated with the UE and for the service data packet set.

In some embodiments of the present disclosure, based on the above solutions, the generating unit 1204 is configured to generate, based on the QoS requirement information and an SLA negotiated with an AF, the alternative QoS policy information for the service data packet set.

In some embodiments of the present disclosure, based on the above solutions, the generating unit 1204 is configured to determine the priority of the UE based on the SLA; and generate, based on the QoS requirement information and the priority of the UE, the alternative QoS policy information for the service data packet set.

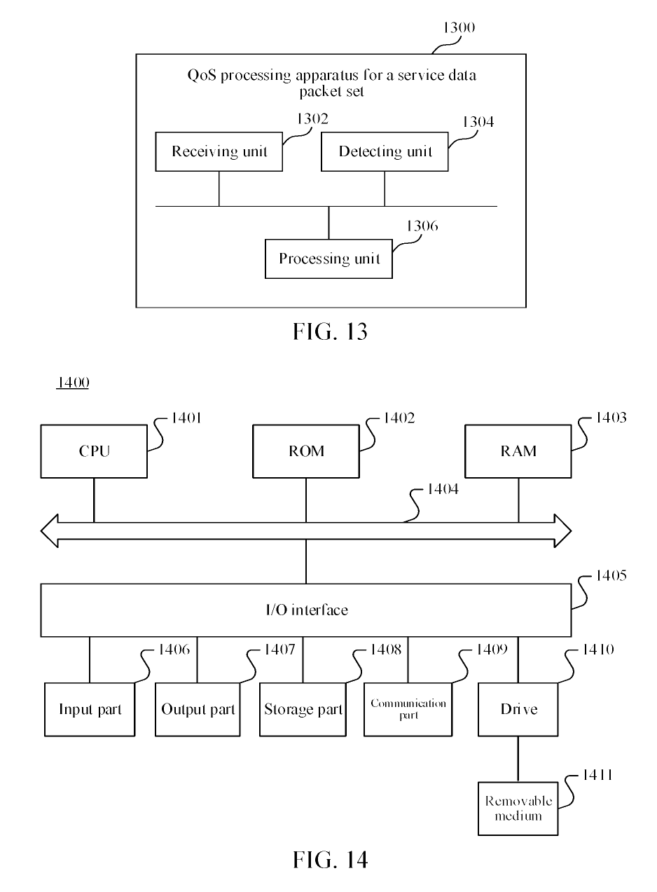

FIG. 13 is a block diagram of a QoS processing apparatus for a service data packet set according to an embodiment of the present disclosure. The QoS processing apparatus for a service data packet set may be applied to an access network device or another device.

Referring to FIG. 13, a QoS processing apparatus 1300 for a service data packet set according to an embodiment of the present disclosure includes: a receiving unit 1302, a detecting unit 1304, and a processing unit 1306.

The receiving unit 1302 is configured to receive alternative QoS policy information for the service data packet set, the alternative QoS policy information being generated by a PCF based on QoS requirement information of a service data flow, the QoS requirement information indicating that a service data packet set in the service data flow adopts alternative QoS configuration information. The detecting unit 1304 is configured to detect QoS parameters of the service data packet set during transmission. The processing unit 1306 is configured to transmit first notification information to a core network element if the QoS parameters of the service data packet set during the transmission do not match the alternative QoS policy information in order to trigger a PDU session modification process.

In some embodiments of the present disclosure, based on the above solutions, the processing unit 1306 is configured to reselect, if a part of the QoS parameters of the service data packet set during the transmission does not match the alternative QoS policy information, a QoS parameter for the part of the QoS parameters based on the alternative QoS policy information.

In some embodiments of the present disclosure, based on the above solutions, the processing unit 1306 is configured to transmit second notification information to the core network element to notify that the part of the QoS parameters has been reselected.

FIG. 14 is a schematic structural diagram of a computer system of an electronic device configured to implement embodiments of the present disclosure. The electronic device may be the AF, the PCF, or the access network device in the foregoing embodiments.

A computer system 1400 of an electronic device shown in FIG. 14 is merely an example, and does not constitute any limitation on functions and a range of application of the embodiments of the present disclosure.

As shown in FIG. 14, the computer system 1400 may include a central processing unit (CPU) 1401, which may perform various suitable actions and processes based on a program stored in a read-only memory (ROM) 1402 or a program loaded from a storage part 1408 into a random access memory (RAM) 1403, for example, perform the method in the foregoing embodiments. In the RAM 1403, various programs and data required for system operation are further stored. The CPU 1401, the ROM 1402, and the RAM 1403 are connected to each other through a bus 1404. An input/output (I/O) interface 1405 is also connected to the bus 1404.

The following components may be connected to the I/O interface 1405: an input part 1406, including a keyboard, a mouse, and the like; an output part 1407, including a cathode ray tube (CRT), a liquid crystal display (LCD), or the like, and a speaker, or the like; a storage part 1408, including a hard disk, and the like; and a communication part 1409, including a network interface card such as a local area network (LAN) card and a modem. The communication part 1409 performs communication through a network such as the Internet. A drive 1410 is also connected to the I/O interface 1405 as required. A removable medium 1411, such as a magnetic disk, an optical disk, a magneto-optical disk, or a semiconductor memory, is installed on the drive 1410 as required, so that a computer program read out therefrom is installed into the storage part 1408 as required.

In particular, according to the embodiments of the present disclosure, the process described by referring to the flowchart in the above may be implemented as a computer software program. For example, the embodiments of the present disclosure include a computer program product, the computer program product including a computer program carried on a computer-readable medium, the computer program being configured to perform the method shown in the flowchart. In such an embodiment, the computer program may be downloaded and installed from a network through the communication part 1409, and/or installed from the removable medium 1411. When the computer program is executed by the CPU 1401, various functions defined in the system of the present disclosure are performed.

The computer-readable medium shown in the embodiments of the present disclosure may be a computer-readable signal medium, a computer-readable storage medium, or any combination of the above. The computer-readable storage medium may be, for example, but is not limited to, an electric, magnetic, optical, electromagnetic, infrared, or semiconductor system, apparatus, device, or any combination thereof. More particularly, the computer-readable storage medium may be, for example, but is not limited to, an electrical connection having one or more wires, a portable computer magnetic disk, a hard disk, a RAM, a ROM, an erasable programmable read-only memory (EPROM), a flash memory, an optical fiber, a portable compact disk read-only memory (CD-ROM), an optical storage device, a magnetic storage device, or any suitable combination thereof. In the present disclosure, the computer-readable storage medium may be any tangible medium that includes a computer program or has a computer program stored therein. The computer program may be used by or used in combination with an instruction execution system, apparatus, or device. In the present disclosure, the computer-readable signal medium may include a data signal transmitted in a baseband or as a part of a carrier, and carries a computer-readable computer program. The propagated data signal may be in various forms, including but not limited to an electromagnetic signal, an optical signal, or any suitable combination thereof. The computer-readable signal medium may alternatively be any computer-readable medium other than the computer-readable storage medium. The computer-readable medium may transmit, propagate, or transmit a program used by or used in combination with an instruction execution system, apparatus, or device. The computer program included in the computer-readable medium may be transmitted by using any suitable medium, including but not limited to a wireless medium, a wired medium, or the like, or any suitable combination thereof.

The flowcharts and the block diagrams in the drawings illustrate possible system architectures, functions, and operations that may be implemented by a system, a method, and a computer program product according to various embodiments of the present disclosure. Each block in the flowcharts or the block diagrams may represent a module, a program segment, or a part of code. The module, the program segment, or the part of code includes one or more executable instructions used for implementing specified logic functions. In some alternative implementations, the functions marked in the blocks may occur in an order different from that marked in the drawings. For example, two blocks shown in succession may actually be performed substantially in parallel, or may sometimes be performed in a reverse order, which depends on the functions involved. Each block in the block diagrams or the flowcharts and combinations of the blocks in the block diagrams or the flowcharts may be implemented by a dedicated hardware-based system that performs specified functions or operations, or may be implemented by a combination of dedicated hardware and a computer program.

The units described in the embodiments of the present disclosure may be implemented through software or hardware, and may be arranged in a processor. Names of the units do not constitute a limitation on the units in a specific case.

In another aspect, the present disclosure further provides a computer-readable medium. The computer-readable medium may be included in the electronic device described in the foregoing embodiments, or may exist alone without being installed into the electronic device. The foregoing computer-readable medium carries one or more computer programs. The one or more computer programs, when executed by the electronic device, cause the electronic device to implement the method described in the foregoing embodiments.

Although a plurality of modules or units of a device configured to perform actions are mentioned in the foregoing detailed description, such division is not mandatory. Actually, according to the implementations of the present disclosure, the features and functions of two or more modules or units described above may be specifically implemented in one module or unit. On the contrary, the features and functions of one module or unit described above may further be divided to be embodied by a plurality of modules or units.

According to the foregoing descriptions of the implementations, a person skilled in the art may readily understand that the exemplary implementations described herein may be implemented by using software, or may be implemented by combining software and necessary hardware. Therefore, the technical solution according to the implementations of the present disclosure may be embodied in a form of a software product. The software product may be stored in a non-volatile storage medium (which may be a CD-ROM, a USB flash drive, a removable hard disk, or the like) or on a network, including a plurality of instructions configured for enabling an electronic device to perform the method according to the implementations of the present disclosure.

For example, the electronic device may be the AF, and the AF may perform the QoS processing method for a service data packet set shown in FIG. 3. For another example, the electronic device may be the PCF, and the PCF may perform the QoS processing method for a service data packet set shown in FIG. 4. For yet another example, the electronic device may be an access network device, and the access network device may perform the QoS processing method for a service data packet set shown in FIG. 6.

A person skilled in the art may easily figure out another implementation of the present disclosure after considering the specification and practicing the implementations disclosed herein. The present disclosure is intended to cover any variations, usages, or adaptive changes of the present disclosure. These variations, usages, or adaptive changes follow the general principles of the present disclosure and include common general knowledge or common technical means in the art not disclosed in the present disclosure.

The present disclosure is not limited to the precise structures described above and shown in the drawings, and various modifications and changes may be made without departing from the scope of the present disclosure. The scope of the present disclosure is limited only by the appended claims.

What is claimed is:

1. A quality of service (QoS) processing method for a service data packet set, the method comprising:
obtaining QoS requirement information for a service data flow, the QoS requirement information indicating that a service data packet set in the service data flow adopts alternative QoS configuration information;
generating alternative QoS policy information for the service data packet set based on the QoS requirement information; and
transmitting the alternative QoS policy information to a session management function (SMF) to enable the SMF to configure the alternative QoS policy information for a device that processes the service data packet set.

2. The method according to claim 1, wherein the alternative QoS policy information comprises at least one of the following information:
second indication information configured to indicate whether to map data of different media types comprised in the service data flow to different QoS flows;
third indication information configured to indicate whether to map the data of different media types comprised in the service data flow to a same QoS flow;
fourth indication information configured to indicate whether importance of the different media types is indicated through importance information of the service data packet set if the data of the different media types comprised in the service data flow is mapped to the different QoS flows; and
fifth indication information configured to indicate that if the data of the different media types comprised in the service data flow is mapped to the same QoS flow, the alternative QoS policy information representing an integrated policy for the same QoS flow.

3. The method according to claim 1, wherein the generating alternative QoS policy information for the service data packet set based on the QoS requirement information comprises:
generating, if the QoS requirement information comprises alternative QoS configuration information respectively corresponding to service data packet sets of different media types and the data of the different media types needs to be mapped to the same QoS flow, the integrated policy for the same QoS flow based on the alternative QoS configuration information respectively corresponding to the service data packet sets of the different media types.

4. The method according to claim 3, wherein the generating the integrated policy for the same QoS flow based on the alternative QoS configuration information respectively corresponding to the service data packet sets of the different media types comprises:
superimposing, if the alternative QoS configuration information comprises bandwidth requirement information, bandwidth requirement information of the different media types to generate an integrated policy for the bandwidth requirement information;
generating, if the alternative QoS configuration information comprises a protocol data unit set delay budget (PSDB) requirement information, an integrated policy for the PSDB requirement information based on a minimum value of PSDB requirements in the different media types;
generating, if the alternative QoS configuration information comprises PSER requirement information, an integrated policy for the PSER requirement information based on a minimum value of PSER requirements in the different media types;
generating, if the alternative QoS configuration information comprises maximum data burst volume (MDBV) requirement information, an integrated policy for the MDBV requirement information based on a maximum value of MDBV requirements for the different media types, or superimposing the MDBV requirement information in the different media types to generate an integrated policy for the MDBV requirement information; and
generating, if the alternative QoS configuration information comprises packet delay variation (PDV) requirement information, an integrated policy for the PDV requirement information based on a minimum value of PDV requirements in the different media types.

5. The method according to claim 1, wherein the generating alternative QoS policy information for the service data packet set based on the QoS requirement information comprises:
respectively generating, if the data of the different media types comprised in the service data flow needs to be mapped to the different QoS flows, the alternative QoS policy information for service data packet sets in the different QoS flows.

6. The method according to claim 5, wherein the alternative QoS policy information comprises at least one of the following information:
a selectable numerical value range of QoS parameters for the service data packet set; and
a selectable numerical value of each of the QoS parameters for the service data packet set.

7. The method according to claim 1, wherein the generating alternative QoS policy information for the service data packet set based on the QoS requirement information comprises:
generating, based on the QoS requirement information and subscription information of a user equipment (UE) for processing the service data packet set, the alternative QoS policy information associated with the UE and for the service data packet set.

8. The method according to claim 7, wherein the generating, based on the QoS requirement information and subscription information of a user equipment (UE) for processing the service data packet set, the alternative QoS policy information associated with the UE and for the service data packet set comprises:
determining a priority of the UE based on the subscription information of the UE; and
generating, based on the QoS requirement information and the priority of the UE, the alternative QoS policy information associated with the UE and for the service data packet set.

9. The method according to claim 1, wherein the generating alternative QoS policy information for the service data packet set based on the QoS requirement information comprises:
generating, based on the QoS requirement information and a service level agreement (SLA) negotiated with an application function (AF), the alternative QoS policy information for the service data packet set.

10. The method according to claim 9, wherein the generating, based on the QoS requirement information and a service level agreement (SLA) negotiated with an application function (AF), the alternative QoS policy information for the service data packet set comprises:
determining a priority of a UE based on the SLA; and
generating the alternative QoS policy information for the service data packet set based on the QoS requirement information and the priority of the UE.

11. A QoS processing apparatus for a service data packet set, the apparatus comprising:
at least one memory configured to store program code; and
at least one processor configured to read the program code and operate as instructed by the program code, the program code comprising:
an obtaining code configured to cause the at least one of the at least one processor to obtain QoS requirement information for a service data flow, the QoS requirement information indicating that a service data packet set in the service data flow adopts alternative QoS configuration information;
a first generating code configured to cause the at least one of the at least one processor to generate alternative QoS policy information for the service data packet set based on the QoS requirement information; and
a transmitting code configured to cause the at least one of the at least one processor to transmit the alternative QoS policy information to an SMF to enable the SMF to configure the alternative QoS policy information for a device that processes the service data packet set.

12. The QoS processing apparatus according to claim 11, wherein the alternative QoS policy information comprises at least one of the following information:
second indication information configured to indicate whether to map data of different media types comprised in the service data flow to different QoS flows;
third indication information configured to indicate whether to map the data of different media types comprised in the service data flow to a same QoS flow;
fourth indication information configured to indicate whether importance of the different media types is indicated through importance information of the service data packet set if the data of the different media types comprised in the service data flow is mapped to the different QoS flows; and
fifth indication information configured to indicate that if the data of the different media types comprised in the service data flow is mapped to the same QoS flow, the alternative QoS policy information representing an integrated policy for the same QoS flow.

13. The QoS processing apparatus according to claim 11, wherein the first generating code comprises a second generating code configured to cause at least one of the at least one processor to:
generate, if the QoS requirement information comprises alternative QoS configuration information respectively corresponding to service data packet sets of different media types and the data of the different media types needs to be mapped to the same QoS flow, the integrated policy for the same QoS flow based on the alternative QoS configuration information respectively corresponding to the service data packet sets of the different media types.

14. The QoS processing apparatus according to claim 13, wherein the second generating code comprises:
a superimposing code configured to cause at least one of the at least one processor to superimpose, if the alternative QoS configuration information comprises bandwidth requirement information, bandwidth requirement information of the different media types to generate an integrated policy for the bandwidth requirement information;
a third generating code configured to cause at least one of the at least one processor to generate, if the alternative QoS configuration information comprises a protocol data unit set delay budget (PSDB) requirement information, an integrated policy for the PSDB requirement information based on a minimum value of PSDB requirements in the different media types;
a fourth generating code configured to cause at least one of the at least one processor to generate, if the alternative QoS configuration information comprises PSER requirement information, an integrated policy for the PSER requirement information based on a minimum value of PSER requirements in the different media types;
a fifth generating code configured to cause at least one of the at least one processor to generate, if the alternative QoS configuration information comprises maximum data burst volume (MDBV) requirement information, an integrated policy for the MDBV requirement information based on a maximum value of MDBV requirements for the different media types, or superimposing the MDBV requirement information in the different media types to generate an integrated policy for the MDBV requirement information; and
a sixth generating code configured to cause at least one of the at least one processor to generate, if the alternative QoS configuration information comprises packet delay variation (PDV) requirement information, an integrated policy for the PDV requirement information based on a minimum value of PDV requirements in the different media types.

15. The QoS processing apparatus according to claim 11, wherein the first generating code comprises a seventh generating code configured to cause at least one of the at least one processor to:
respectively generate, if the data of the different media types comprised in the service data flow needs to be mapped to the different QoS flows, the alternative QoS policy information for service data packet sets in the different QoS flows.

16. A non-transitory computer-readable storage medium, storing computer code which, when executed by at least one processor, causes the at least one processor to at least:
obtain QoS requirement information for a service data flow, the QoS requirement information indicating that a service data packet set in the service data flow adopts alternative QoS configuration information;
generate alternative QoS policy information for the service data packet set based on the QoS requirement information; and
transmit the alternative QoS policy information to a session management function (SMF) to enable the SMF to configure the alternative QoS policy information for a device that processes the service data packet set.

17. The non-transitory computer-readable storage medium according to claim 16, wherein the alternative QoS policy information comprises at least one of the following information:
second indication information configured to indicate whether to map data of different media types comprised in the service data flow to different QoS flows;
third indication information configured to indicate whether to map the data of different media types comprised in the service data flow to a same QoS flow;
fourth indication information configured to indicate whether importance of the different media types is indicated through importance information of the service data packet set if the data of the different media types comprised in the service data flow is mapped to the different QoS flows; and
fifth indication information configured to indicate that if the data of the different media types comprised in the service data flow is mapped to the same QoS flow, the alternative QoS policy information representing an integrated policy for the same QoS flow.

18. The non-transitory computer-readable storage medium according to claim 16, wherein the generating alternative QoS policy information for the service data packet set based on the QoS requirement information comprises:
generating, if the QoS requirement information comprises alternative QoS configuration information respectively corresponding to service data packet sets of different media types and the data of the different media types needs to be mapped to the same QoS flow, the integrated policy for the same QoS flow based on the alternative QoS configuration information respectively corresponding to the service data packet sets of the different media types.

19. The non-transitory computer-readable storage medium according to claim 18, wherein the generating alternative QoS policy information for the service data packet set based on the QoS requirement information comprises:
wherein the generating the integrated policy for the same QoS flow based on the alternative QoS configuration information respectively corresponding to the service data packet sets of the different media types comprises:
superimposing, if the alternative QoS configuration information comprises bandwidth requirement information, bandwidth requirement information of the different media types to generate an integrated policy for the bandwidth requirement information;
generating, if the alternative QoS configuration information comprises a protocol data unit set delay budget (PSDB) requirement information, an integrated policy for the PSDB requirement information based on a minimum value of PSDB requirements in the different media types;
generating, if the alternative QoS configuration information comprises PSER requirement information, an integrated policy for the PSER requirement information based on a minimum value of PSER requirements in the different media types;
generating, if the alternative QoS configuration information comprises maximum data burst volume (MDBV) requirement information, an integrated policy for the MDBV requirement information based on a maximum value of MDBV requirements for the different media types, or superimposing the MDBV requirement information in the different media types to generate an integrated policy for the MDBV requirement information; and
generating, if the alternative QoS configuration information comprises packet delay variation (PDV) requirement information, an integrated policy for the PDV requirement information based on a minimum value of PDV requirements in the different media types.

20. The non-transitory computer-readable storage medium according to claim 16, wherein the generating alternative QoS policy information for the service data packet set based on the QoS requirement information comprises:
respectively generating, if the data of the different media types comprised in the service data flow needs to be mapped to the different QoS flows, the alternative QoS policy information for service data packet sets in the different QoS flows.
